(19) United States
(12) Patent Application Publication
(10) Pub. No.: US 2024/0038132 A1
(43) Pub. Date: Feb. 1, 2024

(54) CONTROLLING VEHICLE DISPLAY FOR ENHANCEMENT

(71) Applicant: Ford Global Technologies, LLC, Dearborn, MI (US)

(72) Inventors: Stuart C. Salter, White Lake, MI (US); Hussein H. Berry, Dearborn, MI (US); Brendan Francis Diamond, Grosse Pointe, MI (US); Lucretia Williams, Bloomfield Hills, MI (US); Annette Lynn Huebner, Highland, MI (US)

(73) Assignee: Ford Global Technologies, LLC, Dearborn, MI (US)

(21) Appl. No.: 17/814,924

(22) Filed: Jul. 26, 2022

(51) Int. Cl. G09G 3/20; G06V 20/59; G06V 40/16; B60K 35/00

(52) U.S. Cl. CPC G09G 3/2092; G06V 20/597; G06V 40/178; B60K 35/00; G09G 2360/144; G09G 2380/10; G09G 2354/00; G09G 2320/066; G09G 2320/0666; G09G 2340/045; G09G 2320/08; G09G 2320/0606; B60K 2370/33; B60K 2370/12

(57) ABSTRACT

An age of an operator of a vehicle and a light condition in the vehicle are determined. A pattern for display is selected based on the determined age of the operator of the vehicle and the light condition in the vehicle. The pattern is presented on the display on the display. Then the display is adjusted based on input from the vehicle operator in response to the pattern.

### BACKGROUND

Vehicles are equipped with displays that can present information to a vehicle operator. A vehicle display can present information such as speed, fuel level, direction of travel, music being played, climate control, etc. The information may be presented in the form of text and images. A display may be implemented using chips, electronic components, and/or light emitting diode (LED), liquid crystal display (LCD), organic light emitting diode (OLED), etc.

### BRIEF DESCRIPTION OF THE DRAWINGS

FIG. 1 is a block diagram of an example vehicle.

FIG. 2 illustrates an example vehicle display including a test pattern.

FIG. 3 illustrates an example vehicle display including an operational pattern.

FIG. 4 is a process flow diagram of an example process for controlling the display of the vehicle.

### DETAILED DESCRIPTION

### Introduction

The present disclosure provides a system and method for adjusting a display 102 in a vehicle 104. In one implementation, a pattern for a display can be selected based on a determined age of a user, e.g., an operator, of a vehicle 104 and/or a light condition in the vehicle 104. The pattern can then be presented on the display 102. A vehicle user can provide input concerning the pattern. The display 102 can then be controlled to adjust an output of the display 102 based on user input from the vehicle operator in response to the pattern. Accordingly, as described herein, a vehicle computer 104 can adjust output of a vehicle display 102 in a manner to facilitate enhanced formatting and presentation of the display content.

Accordingly, included in the present disclosure is a system comprising a computer that includes a processor and a memory, the memory stores instructions executable by the processor including instructions to select a pattern for a display based on a determined age of an operator of a vehicle and a light condition in the vehicle; present the pattern on the display; and adjust the display based on input from the vehicle operator in response to the pattern.

The light condition can be determined at least in part based on an orientation of the vehicle with respect to the sun.

The pattern can define at least one of a color, a font, or a scale of the display. The pattern can increase a color contrast of the display.

The pattern for display can be selected based on a vehicle speed in addition to the determined age of the vehicle operator and the light condition in the vehicle. The pattern for display can be selected based on a road condition in addition to the determined age of the vehicle operator and the light condition in the vehicle.

It can be determined that the vehicle operator is wearing vision correctors and the pattern for display can be selected based on a presence of vision correctors in addition to the determined age of the vehicle operator and the light condition in the vehicle. It can be determined that the vehicle operator is squinting, and the pattern can be selected further based on the squinting. User input selecting a parameter for the pattern can be received, and the pattern can be selected further based on the user input.

The pattern can be presented based on at least one of vehicle speed, vehicle direction of travel, or road conditions.

At least one of the vehicle operator age or the light condition can be based on an image received from a vehicle sensor.

A method comprises selecting a pattern for a display based on a determined age of an operator of a vehicle and a light condition in the vehicle; presenting the pattern on the display; and adjusting the display based on input from the vehicle operator in response to the pattern. The light condition can be determined at least in part based on an orientation of the vehicle with respect to the sun.

The pattern can define at least one of a color, a font, or a scale of the display. The pattern can increase a color contrast of the display.

The pattern for display can be selected based on a vehicle speed in addition to the determined age of the vehicle operator and the light condition in the vehicle. The pattern for display can be selected based on a road condition in addition to the determined age of the vehicle operator and the light condition in the vehicle.

It can be determined that the vehicle operator is wearing vision correctors and the pattern for display can be selected based on a presence of vision correctors in addition to the determined age of the vehicle operator and the light condition in the vehicle. It can be determined that the vehicle operator is squinting, and the pattern can be selected further based on the squinting. User input selecting a parameter for the pattern can be received, and the pattern can be selected further based on the user input.

The pattern can be presented based on at least one of vehicle speed, vehicle direction of travel, or road conditions.

At least one of the vehicle operator age or the light condition can be based on an image received from a vehicle sensor.

### System Elements

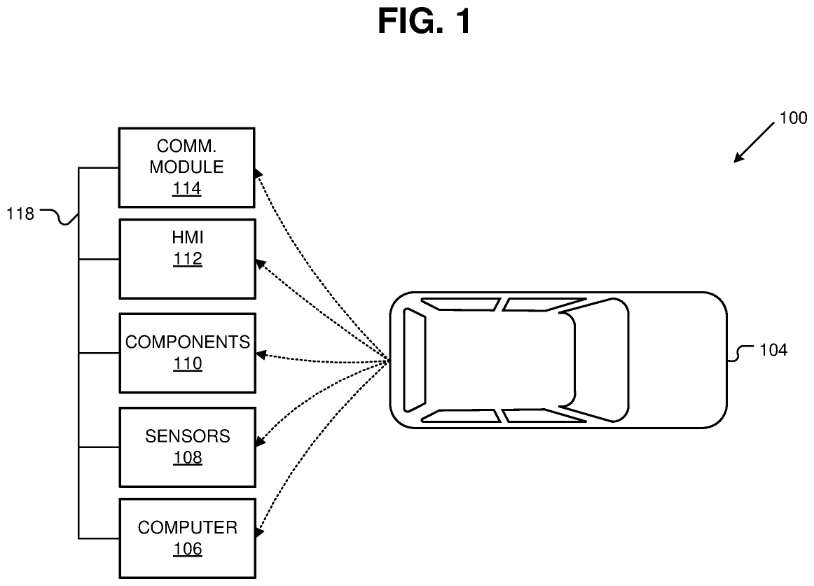

FIG. 1 is a block diagram of a vehicle system 100 for providing an enhanced display 102 in a vehicle. The vehicle 104 includes a computer 106 having a memory that includes instructions executable by the computer to carry out processes and operations including as described herein. The computer 106 may be communicatively coupled via a communication network, such as a vehicle network 118, with sensors 108, components 110, a human machine interface (HMI) 112 and a communication module 114 included in the vehicle 104. The vehicle 104 may be any passenger or commercial automobile such as a car, a truck, a sport utility vehicle, a crossover, a van, a minivan, a taxi, a bus, etc.

The vehicle computer 106 includes a processor and a memory. Further, the vehicle computer 106 could include a plurality of computers in the vehicle 104, e.g., a plurality of ECUs or the like, operating together to perform operations ascribed herein to the vehicle computer 106. A memory of a computer 106 such as those described herein includes one or more forms of computer readable media, and stores instructions executable by the vehicle computer 106 for performing various operations, including as disclosed herein. For example, a vehicle computer 106 can be a generic computer with a processor and memory as described above and/or may include an electronic control unit ECU or controller for a specific function or set of functions, and/or a dedicated electronic circuit including an ASIC (application specific integrated circuit) that is manufactured for a particular operation, e.g., an ASIC for processing sensor data and/or communicating the sensor data. In another example, a vehicle computer 106 may include an FPGA (Field-Programmable Gate Array) which is an integrated circuit manufactured to be configurable by a user. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g. stored in a memory electrically connected to the FPGA circuit. In some examples, a combination of processor(s), ASIC(s), and/or FPGA circuits may be included in a computer 106.

The memory can be of any type, e.g., hard disk drives, solid state drives, servers, or any volatile or non-volatile media. The memory can store the collected data sent from the sensors. The memory can be a separate device from the computer, and the computer can retrieve information stored by the memory via a communication network in the vehicle such as the vehicle network 118, e.g., over a CAN bus, a wireless network, etc. Alternatively or additionally, the memory can be part of the computer 106, e.g., as a memory of the computer 106.

The computer 106 may include programming to operate one or more components 110 such as vehicle brakes, propulsion (e.g., one or more of an internal combustion engine, electric motor, hybrid engine, etc.), steering, climate control, interior and/or exterior lights, etc., as well as to determine whether and when the computer 106, as opposed to a human operator, is to control such operations. Additionally, the computer 106 may be programmed to determine whether and when a human operator is to control such operations. The computer 106 may include or be communicatively coupled to, e.g., via the vehicle network 118, more than one processor, e.g., included in components 110 such as sensors, electronic control units (ECUs) or the like included in the vehicle 104 for monitoring and/or controlling various vehicle components 110 , e.g., a powertrain controller, a brake controller, a steering controller, etc.

The vehicle 104 typically includes a variety of sensors 108. A sensor 108 is a device that can obtain one or more measurements of one or more physical phenomena. Some sensors 108 detect internal states of the vehicle 104, for example, wheel speed, wheel orientation, and engine and transmission variables. Some sensors 108 detect the position or orientation of the vehicle 104, for example, global positioning system GPS sensors; accelerometers such as piezo -electric or microelectromechanical systems MEMS; gyroscopes such as rate, ring laser, or fiber-optic gyroscopes; inertial measurements units IMU; and magnetometers. Some sensors 108 detect the external world, for example, radar sensors, scanning laser range finders, light detection and ranging LIDAR devices, and image processing sensors such as cameras. A LIDAR device detects distances to objects by emitting laser pulses and measuring the time of flight for the pulse to travel to the object and back. Some sensors 108 are communications devices, for example, vehicle-to-infrastructure V2I or vehicle-to-vehicle V2V devices. Sensor 108 operation can be affected by obstructions, e.g., dust, snow, insects, etc. Often, but not necessarily, a sensor 108 includes a digital-to-analog converter to converted sensed analog data to a digital signal that can be provided to a digital computer, e.g., via a network.

Sensors 108 can include a variety of devices, and can be disposed to sense an environment, provide data about a machine, etc., in a variety of ways. For example, a sensor 108 could be mounted to a stationary infrastructure element on, over, or near a road. Moreover, various controllers in a vehicle 104 may operate as sensors 108 to provide data via the vehicle network 118 or bus, e.g., data relating to vehicle speed, acceleration, location, subsystem and/or component 110 status, etc. Further, other sensors 108, in or on a vehicle 104, stationary infrastructure element, etc., infrastructure could include cameras, short range radar, long range radar, LIDAR, and/or ultrasonic transducers, weight sensors, accelerometers, motion detectors, etc., i.e., sensors to provide a variety of data. To provide just a few non-limiting examples, sensor data could include data for determining a position of a component, a location of an object, a speed of an object, a type of an object, a slope of a roadway, a temperature, a presence or amount of moisture, a fuel level, a data rate, a sunlight level, etc.

The vehicle 104 can include an HMI (human-machine interface) 112, e.g., one or more of a display 102, a touchscreen display 102, a microphone, a speaker, etc. The user can provide input to devices such as the computer 106 via the HMI 112. The HMI 112 can communicate with the computer 106 via the vehicle network 118, e.g., the HMI 112 can send a message including the user input provided via a touchscreen, microphone, a camera that captures a gesture, etc., to a computer 106, and/or can display output, e.g., via a screen, speaker, etc. Further, operations of the HMI 112 could be performed by a portable user device (not shown) such as a smart phone or the like in communication with the vehicle computer 106, e.g., via Bluetooth or the like.

The HMI 112 includes the display 102. The display 102 presents information to and receives information from an occupant of the vehicle 104. The display 102 presents information such as speed, fuel level, direction of travel, etc. The information may be presented in the form of text 116 and images. The text 116 and images are adjustable as described in further detail below. The HMI 112 may be located, e.g., on an instrument panel in a passenger cabin of the vehicle, or wherever may be readily seen by the occupant. The HMI 112 may include dials, digital readouts, screens, speakers, and so on for providing information to the occupant, e.g., human-machine interface (HMI) elements such as are known. The HMI 112 may include buttons, knobs, keypads, microphone, and so on for receiving information from the occupant. A display 102 may be implemented using chips, electronic components, and/or light emitting diode (LED), liquid crystal display (LCD), organic light emitting diode (OLED), etc. The display may receive image frames from the computer, e.g., via the vehicle network 118, etc.

### Exemplary System Operations

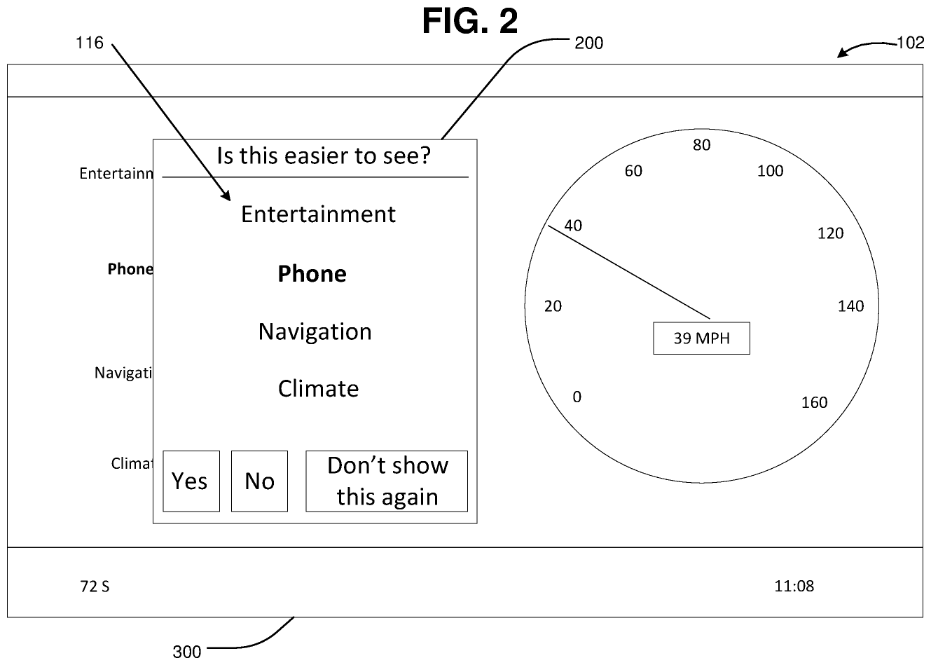

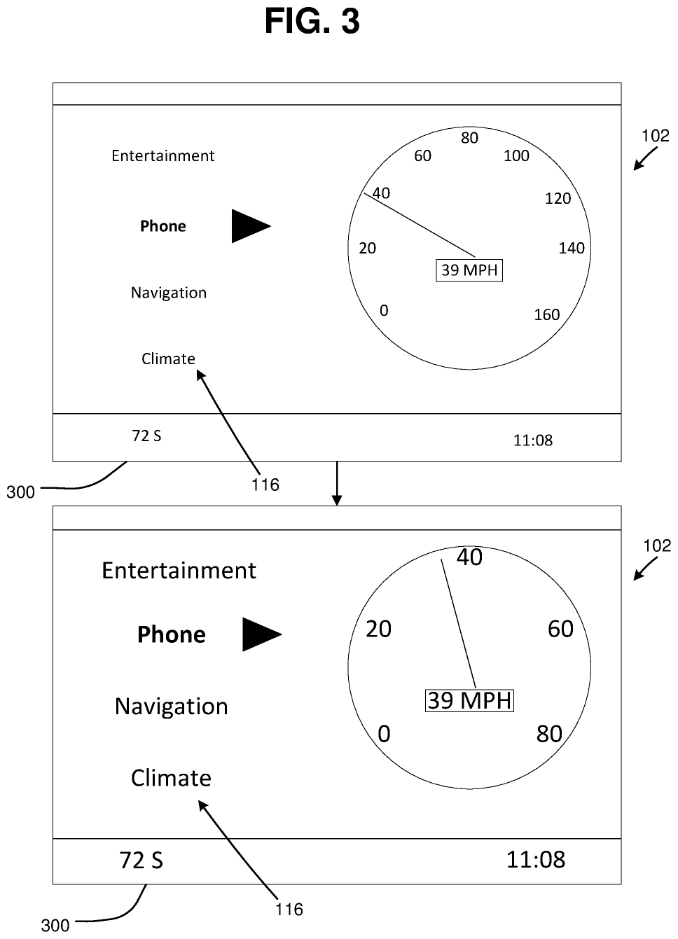

FIGS. 2 and 3 show example patterns that could be presented via a display 102. Display patterns herein include test patterns 200 and operation patterns 300. FIG. 2 shows an example test pattern 200. A test pattern 200 is presented to the user based on a determination made by the computer 106, and is presented to receive user input concerning one or more display parameters. Based on user input in response to the test pattern 200, the computer 106 can then adjust display parameters for the operational pattern 300 on the display 102 as shown in FIG. 3, thereby providing the operator with an enhanced display 102. A display parameter in the context of this disclosure is measurement or specification of a display element. For example, a specified display element could be a font, and a measurement could be a font size.

In an example, based on a determined operator age, and possibly also on an orientation of the vehicle 104 with respect to the sun, and possibly also other factors discussed further below, the computer 106 can determine a test pattern 200 to present to the user. A test pattern 200 can define one or more of a color, a font, or a scale (i.e., size of output elements such as images and/or characters) for output on the display 102, such tangible attributes of the display 102 or display elements being referred to herein as display parameters, as noted above. Accordingly, the test pattern 200 is selected, based on the user's age and/or light conditions, to obtain user input with respect to one or more display parameters such as color, font, or scale. For example, the test pattern 200 can specify to increase or decrease a parameter of the elements presented on the display 102, such as increasing or decreasing a color contrast or increasing or decreasing a scale. Further, the test pattern could specify a font, e.g., serif versus sans-serif, or could specify a specific font, e.g., Arial.

FIG. 3 shows the operational pattern 300 before and after being adjusted according to the user input in response to the test pattern 200 as shown in FIG. 2. In the example shown, the test pattern 200 shows an increase in the text 116 size and requests user input as to whether the adjustment enhances readability. Based on the user input, one or more parameters of the test pattern 200 can then be applied to output the operational pattern 300.

The vehicle computer 106 could determine the age of the vehicle operator based on vehicle sensor data and/or user input. The computer could activate the display 102 in the HMI 112 to request the user to input an age. Alternatively or additionally, an operator age could be determined based on imaging analysis. That is, a vehicle camera sensor 108 could provide one or more images of a user, typically of the user's face, and a machine learning program could be applied to predict the user's age. For example, a deep neural network (DNN) could be trained in a conventional manner to receive an image including a user's face as input, and to output the predicted age.

The computer 106 may detect driving conditions by interpreting data from a sensor 108 in the vehicle 104. Driving conditions herein refer to light conditions, travel conditions, environmental conditions, and any other condition which may have an impact on the ability of the vehicle operator to read the display 102 as described in further detail below.

A driving condition such as a light condition could be determined by the vehicle computer 106 based at least in part on data collected by a sensor 108 in the vehicle 104. A light condition herein means a measurement that describes ambient lighting, e.g., a light intensity detected by an optical sensor 108 in the vehicle 104 and measured in lumens. Light conditions can result from light emanating from the sun and/or artificial lights such as light emitting diodes (LEDs), e.g., in a vehicle HMI display 102, etc. For example, the vehicle could include optical sensors 108 positioned to detect ambient light outside the vehicle 104.

Based on the detected light, image analysis techniques could be implemented to predict an orientation of the vehicle 104 with respect to the sun. Alternatively or additionally, an orientation of the vehicle 104 with respect to the sun could be determined based on determining an orientation of the vehicle 104, and then using stored data about a position of the sun at a current time of day and day of the year to determine the vehicle 104 orientation with respect to the sun. Herein, an orientation of the vehicle 104 means a heading or direction of the vehicle 104 determined along a longitudinal axis of the vehicle 104. Further, an orientation can be specified with respect to a coordinate system. For example, an orientation could be specified as a vehicle 104 heading with respect to geo-coordinates, e.g., in a global coordinate system such as used in the Global Navigation Satellite System (GNSS). For example, a vehicle 104 heading could be specified as an angle of deviation from true north. A vehicle 104 orientation with respect to the sun could then be determined as an angle of difference between the vehicle 104 heading and a horizontal line from the vehicle 104 to a location on the horizon perpendicularly below the sun.

The computer 106 may monitor light conditions and determine if the vehicle operator is predicted to be squinting before presenting a test pattern 200 on the display 102 based on determined light conditions. For example, the computer 106 could input an image of the vehicle operator to a machine learning program that outputs a determination that the operator is or is not squinting as described in further detail below. The computer 106 may also determine that the light conditions have changed sufficiently for a determination of a squinting prediction to be made and a test pattern 200 to be presented. As an example, the computer 106 may access a lookup table or the like. The lookup table may list condition values, described in further detail below, according to which the vehicle user may be predicted to be squinting.

Table 1 is an example lookup table specifying condition values according to which the computer 106 may determine a prediction that an occupant is squinting based on light conditions, and may determine to present a test pattern 200. As used herein, a condition value means a measurement of a current physical state or fact, e.g., a time, a light intensity, and occupant's age, etc.

TABLE 1

| Test | Condition value 1 | | Condition value 2 | Condition value 3 |
|---|---|---|---|---|
| Pattern | (Light Intensity) | | (Time of Day) | (Orientation to Sun) |
| None | <5.0 | Lux | NULL | NULL |
| Pattern1 | <8.0 | Lux | 1800-0600 | NULL |
| Pattern2 | >8.0 | Lux | 0600-0900 | 0° + 30° |
| Pattern2 | >8.0 | Lux | 01700-1900 | 0° + 30° |
| Pattern3 | >10 | Lux | 0900-1700 | NULL |

Table 1 includes a plurality of records defining condition values for which various test patterns 200 (or no test pattern 200) may be presented via the vehicle HMI 112. For example, based on a data set such as shown in Table 1, the computer 106 could determine not to present a test pattern 200 based on a light intensity being below a threshold irregardless of other condition values. (That is, “NULL” in Table 1 indicates that that condition value is not considered.) Further, different patterns could be stored and used based on various driving conditions in the vehicle 104, i.e., based on currently determined condition values, e.g., via vehicle sensors 108 (e.g., light intensity or orientation) and/or data maintained by the vehicle computer 106 and/or received by some other computer 106 on the vehicle network 118 (e.g., time of day, day of year, etc.)

A condition value for a light intensity can be determined from data collected by an optical sensor 108 in the vehicle 104. That is, light intensity can be determined by analyzing pixels in a digital image, as is known. Light intensity can be measured in lumens per square meter (Lux).

With continued reference to Table 1, time of day refers to a time of day at a vehicle 104 location, shown in 24-hour notation. Further, because the sun is positioned differently with respect to a given location at a given time of day depending on a day of the year, the time of day values in table 1 may be adjusted accordingly, e.g., the computer 106 could store further data for adjusting time of day values based on a day of the year. Values for times of day stored by the computer 106 for selecting a test pattern 200, e.g., as shown in Table 1, can be based on empirical data about a light intensity at respective times of day at a location.

Further, the computer 106 may consider an orientation of the vehicle 104 relative to the sun when making a determination of whether to present a test pattern 200. As described above, an orientation of the vehicle 104 can then be used to determine an orientation of the vehicle 104 with respect to the sun based on a global location of the vehicle 104. A vehicle 104 orientation with respect to the sun can be determined as an angle of difference between the vehicle 104 heading and a horizontal line from the vehicle 104 to a location on the horizon closest to and perpendicularly below the sun.

As has been explained, time of day and orientation of the vehicle 104 relative to the sun as mentioned in Table 1 are specified based on an expected position of the sun in the sky, a time of day, and day of year. The expected position of the sun in the sky is made using data on the time of year and global position. Orientation relative to the sun relies on the time of day in addition to the time of year and global position. The computer 106 may determine the expected position of the sun in the sky based on the time of day, the time of year, and global position, e.g., according to a further lookup table or the like. However, a predicted position of the sun relative to the vehicle 104 may be considered in combination with other factors, such as a light intensity, to account for weather or environmental conditions, e.g., smog, clouds, precipitation, etc., that could affect an occupant's ability to see the display 102.

Further, condition values other than those illustrated in Table 1 could alternatively or additionally be used to predict squinting to present a test pattern 200. For example, the illustrated condition values could further be used in combination with a vehicle occupant's age, and identified vision deficiency of the occupant such as a need for vision correctors or a color deficiency, etc., as described herein.

The vehicle 104 may alternatively or additionally determine that the vehicle operator is squinting based on image data captured by a vehicle camera sensor 108. That is, as mentioned above, a vehicle camera sensor 108 could provide one or more images of a user, typically of a user's vehicle operator's face, and a machine learning program could be applied to detect the user squinting. For example, a deep neural network (DNN) could be trained in a conventional manner to receive an image including a user's face as input, and to output a determination of squinting. For example, the DNN could be trained to detect facial features of the vehicle operator, and to correlate these features with a determination of squinting. As an example, if the sensor captures the vehicle user making specific expressions such as repeatedly straining or narrowing their eyes, the computer may make a new determination of squinting and present a test pattern 200 to the vehicle user as described above. As another example, if the sensor captures the user's pupils contracting the computer may make a new determination of squinting and present a test pattern. The display 102 is then adjusted based on the user input from the vehicle operator.

It is possible that the computer 106 could be programmed to present a default test pattern 200 for any prediction of an occupant of squinting and/or condition values within a range or ranges specifying to present a test pattern 200. However, as illustrated in Table 1, and as mentioned above, the test pattern 200 for display 102 to the vehicle operator could additionally or alternatively be selected based on a variety of factors. These include an operator age and a color deficiency in an operator's vision, etc. that is, the test pattern 200 can be presented to determine parameters for the test pattern 200 that increase or enhance the readability of the display 102 for the vehicle operator. As an example, if the vehicle operator is determined to be above a threshold age, e.g., forty, the computer may increase a scale parameter or parameters of the test pattern 200, e.g., a font size and/or dimensions of an image. The computer 106 may determine that the vehicle operator has a color deficiency and thus change the color of the display 102. Once selected, the test pattern 200 is then presented on the display 102 to be viewed by the vehicle operator. If the vehicle operator is above the threshold age, and/or if data is stored in the computer 106 about the operator indicating a possible color deficiency, the vehicle 104 may increase the intensity of color on the test pattern 200 to suit a color deficiency of the vehicle operator. Color intensity is a measure of how pure a color is. Specifically, color intensity is how close the color's RGB value is to the desired color, as described in further detail below. In other words, color intensity is the measure of how little other colors are present in the original color. As an example, the computer 106 may increase the intensity of a blue color by removing grey pixels and replacing them with blue pixels. The computer 106 may remove such off-color pixels based on user input as described in further detail below.

When used in a digital format such as on a vehicle display 102, color is measured using the red-green-blue system (RGB). RGB is the combination of the base colors of red, green, and blue that can be mixed to create different colors. The number of colors that can be created using the RBG system depends on how many possible values can be used for each of the base colors of red, green and blue. Typically, a color may use 24 bits and so 8 bits are used by each of the three base colors of red, green, and blue. An 8-bit number can represent any number from 0 to 256. Thus, there are 256 values that may be used for red, green, or blue in an 8-bit representation. Because there are three different base colors and each color may have 256 different values, there are 16,777,216 possible colors using the RGB system.

The computer 106 may determine a color deficiency of a user by presenting test patterns 200 and receiving user input. A color deficiency means a person's diminished ability to identify colors, or at least certain colors, and is a result of a process that is occurs with age in which a lens of an eye becomes tinted yellow, creating a yellow filter on a person's vision. This yellow filter can result in a decreased ability to distinguish between different shades of color. To determine an operational pattern 300 addressing a color deficiency, the computer 106 may present a test pattern 200 having differing adjacent colors and prompt the user to provide user input specifying which color is brighter. The computer 106 may present the test pattern multiple times with different colors. The computer may present test patterns 200 until the user has given input for each color used in the display 102.

The test pattern 200 may also increase a color contrast of the display. As an example, if the vehicle computer 106 determines that the light conditions in the vehicle 104 may be adversely affecting operator perception of the display 102, the computer 106 may boost the color contrast of the text 116 on the test pattern 200 by increasing the brightness of one or more colors and decreasing the brightness of one or more other colors in order to compensate for the light conditions and increase readability. The computer 106 may request user input indicating if further color contrast is needed. The computer 106 may determine that the light conditions in the vehicle 104 may be adversely affecting operator perception of the display by using a lookup table or the like such as Table 1 shown above. The threshold at which light conditions may be adversely affecting operator perception of the display 102, as well as appropriate test patterns 200 to then present, may be determined empirically, as explained further below. Once selected, the color contrast is included in a test pattern 200 which is then presented on the display 102 to be viewed by the vehicle operator. Color contrast is calculated by dividing a relative luminance of a lighter color by a relative luminance of a darker color. The result is a ratio ranging from 1:1 which is the existence of no contrast, to 21:1, which is the highest color contrast possible based on the equation described below. A relative luminance of a color is measured by normalizing the relative brightness of a point in the color to 0 for the darkest value and 1 for the lightest value.

Relative luminance is calculated by using the following equations:

Relative Luminance=0.2126*R^{2.2}+0.7152*G^{2.2}+0.0722*B^{2.2}

### Where R, G, and B are:

if R_{sRGB}<=0.04045 then R=R_{sRGB}/12.92 else R=((R_{sRGB}+0.055)/1.055)^{2.4}

if G_{sRGB}<=0.04045 then G=G_{sRGB}/12.92 else G=((G_{sRGB}+0.055)/1.055)^{2.4}

if B_{sRGB}<=0.04045 then B=B_{sRGB}/12.92 else B=((B_{sRGB}+0.055)/1.055)^{2.4}

And R_{sRGB}, G_{sRGB}, and B_{sRGB} are defined as:

R_{sRGB}=R_{8bit}/255

G_{sRGB}=G_{8bit}/255

B_{sRGB}=B_{8bit}/255

With R_{8bi,t} G_{8bit}, B_{8bit} being a value between 0 and 255 as mentioned above

With continued reference to FIG. 2, the display 102 can be adjusted using display parameters based on one or more driving conditions determined from user input. In other words, an adjusted test pattern 200 can be presented to the vehicle operator and the vehicle operator can be asked if the current test pattern 200 enhances the readability of the display 102. As an example, if the vehicle operator inputs that the test pattern 200 does enhance the operator's perception of the display 102, e.g., readability of text 116 characters is enhanced, the test pattern 200 is applied to output the operational pattern 300 on the display 102, e.g., as shown in FIG. 3. If the vehicle operator inputs that the test pattern 200 does not enhance the readability of the display 102, the test pattern 200 is not applied to the operational pattern 300 on the display 102. When the test pattern 200 is applied to the operational pattern 300, parameters of the display's text 116 and images are applied to adjust the operational pattern 300. As another example, when the vehicle operator inputs that the test pattern 200 does not enhance readability, the vehicle 104 may present a second test pattern 200 including a combination of parameter changes distinct from the first test pattern 200. In another example, after applying a test pattern 200 to the operational pattern 300 the vehicle operator may input that the current operational pattern 300 is their preferred operational pattern 300, and the vehicle 104 will cease presenting test patterns 200. The vehicle 104 may resume presenting test patterns 200 if the driving conditions change. The presenting of the test pattern and the user input are part of a vision test.

The vehicle 104 may determine that the vehicle operator is wearing vision correctors and select the test pattern 200 display based on the presence of vision correctors in addition to the determined age of the operator of the vehicle and the light condition in the vehicle. The detection of vision correctors may be made by a camera sensor 108 capturing an image of the vehicle operator wearing vision correctors, e.g., eyeglasses. As an example, if the vehicle 104 determines that the vehicle operator is wearing vision correctors, the test pattern 200 selected may be a test pattern 200 that would be selected for a vehicle operator that is younger than the current vehicle operator.

The vehicle 104 may make further determinations based on the presence of vision correctors or glasses. The computer 106 may use data such as discussed concerning Table 1 above in combination with a determination that the vehicle operator is wearing glasses. For example, if the image data of the vehicle operator is used to determine that the vehicle operator is wearing tinted glasses, the computer 106 may consider this in combination with table 1. The presence of tinted glasses may be a fourth condition value for selecting a test pattern 200. Specifically, the presence of tinted glasses may be sufficient for the computer 106 to determine that light conditions have not changed sufficiently for a new determination of a prediction of squinting to be made. As an example, the presence of tinted glasses may be used by the computer 106 to prevent the computer 106 from attempting to make a determination of a prediction of squinting until the glasses are removed. Alternatively, the presence of tinted glasses may modify the light thresholds. For example, the light intensity threshold may be increased from 5.0 Lux to 10.0 Lux.

The vehicle 105 may present the test pattern 200 on the display 102 based on at least one of predicted vehicle speed or predicted road conditions of a route. Specifically, if the user inputs driving directions on the HMI 112, the vehicle 104 may consider speed and road condition data of the planned route and present a new test pattern 200 on the display 102. Road conditions include any feature of the road on which the vehicle 104 is travelling that may affect an ability of the vehicle 104 to navigate such as wet pavement, mud, cracks, etc. The combination of vehicle speed and road conditions are herein referred to as route conditions. When the predicted route conditions have surpassed an empirically determined threshold the computer 106 may present a new test pattern 200. As an example, the vehicle 104 may present a test pattern 200 including increased font size based on data that the road conditions may include potholes or gravel. Route conditions may be determined based on data about the planned route that may be available on a communication network accessible by multiple vehicles 104.

Empirically determining driving conditions under which to present a test pattern 200, and the test pattern 200 to be presented, can be performed by operating a vehicle 104 in a test environment (e.g., on a test track) or on roadways, where vehicle operators record ratings for various test patterns 200 under various driving conditions. Data about the vehicle operator, such as an age and/or presence or absence of vision correctors, can also be recorded along with the ratings. The ratings can then be used to determine values of lighting, environmental, and/or route conditions, or combinations thereof, for presenting a test pattern 200 and/or a specific test pattern 200 to be presented.

### Example Processes

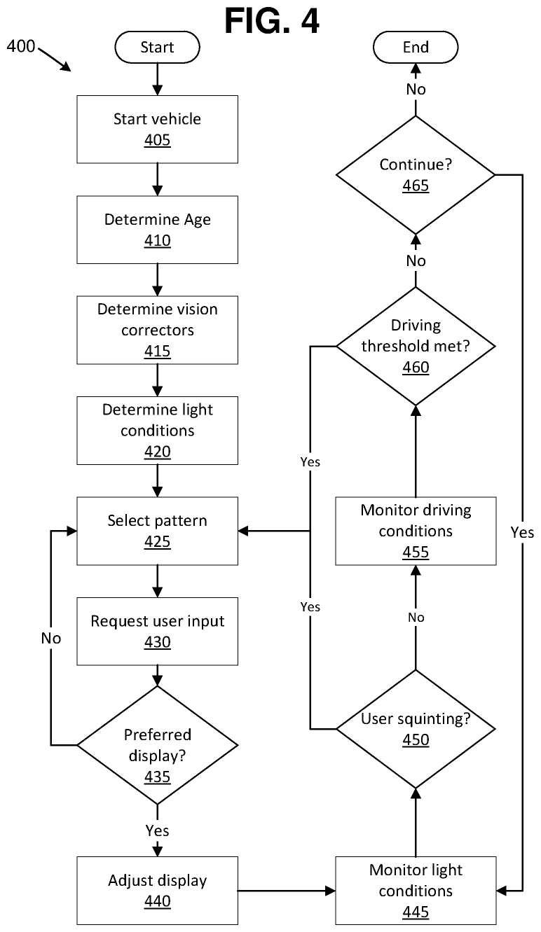

FIG. 4 is a process flow diagram of an example process 400 for providing an enhanced display in a vehicle. The process 400 can be carried out according to program instructions executed in the computer 106. The process 400 begins in a block 405 in which a vehicle 104 is powered to begin normal operations, i.e. a vehicle user such as a vehicle operator activates the vehicle ignition to an ON state and the vehicle begins operation.

Next, in a block 410, the computer determines a vehicle operator age as described above. The vehicle operator age can be stored in a memory of the computer 106.

Next, in a block 415, the computer determines the presence or lack of vision correctors on the vehicle operator as described above. The presence or lack of vision correctors is then stored by the computer 106 to be used in a later block.

Next, in a block 420, the computer determines one or more light conditions in the vehicle. The light conditions can then be stored in a memory of the computer 106.

Then, in a block 425, the computer 106 selects a test pattern 200 to be presented on the display 102. For example, the computer 106 can use the vehicle operator age, the presence or lack of vision correctors, and/or the initial light conditions in the vehicle 104 to make a determination of a test pattern 200 to be presented. The test pattern 200 may vary depending on the operator age, presence of vision correctors, and light conditions, as described above. The computer may determine the test pattern 200 based on evaluating multiple conditions values, e.g., by comparing condition values to reference values stored in a lookup table or the like, e.g., as illustrated by Table 1 above. Condition values not represented in Table 1 could be considered, e.g., operator age and presence of vision correctors. Different condition values indicating a test pattern 200 to be presented may be predetermined and stored in a memory of the computer 106. As an example, if the condition values of Table 1 are at values that warrants a new test pattern 200, the vehicle operator is above a specified age, e.g., forty, and the vehicle operator is not wearing vision correctors, the computer may present a first test pattern 200 increasing a font size and a color contrast of the display 102. As an alternative or additional example, if the condition values of Table 1 were at values warranting a new test pattern 200 and a vehicle operator was over the specified age and wearing vision correctors, the computer 106 could present a second test pattern 200 with additional increases to a font size and/or a color contrast of the display 102.

Next, in a block 430, the computer 106 requests user input regarding the test pattern 200. As an example, based on the determined operator age, lack of vision correctors, and light conditions in the vehicle 104, the computer can determine a test pattern 200 to present to the user. A test pattern 200 can define one or more of a color, a font, or a scale (i.e., size of output elements such as images and/or characters) for output on the display 102, such tangible attributes of the display 102 or display elements being referred to herein as display parameters, as noted above. The computer 106 may request user input by querying if the test pattern 200 enhances the readability of the display 102. The computer 106 requests user input when presenting the test pattern 200. The vehicle operator can be asked if the current test pattern 200 enhances the display 102. The vehicle operator may respond that the test pattern 200 does or does not enhance the display. The vehicle operator may also respond that they do not wish for any new test patterns 200 to be presented. The user input can then be stored in a memory of the computer 106.

Then, as in a block 435, the computer 106 determines whether to repeat the test pattern 200 selection. The computer 106 can determine whether the current test pattern 200 shown on the display 102 is the preferred test pattern 200 of the vehicle operator based on the user input received in the preceding block 430. If the vehicle operator previously specified that the test pattern 200 does not enhance the display 102, the process returns to the block 425 and the computer 106 can select a new test pattern 200 to present to the vehicle operator. If the vehicle operator previously specified that the test pattern 200 does enhance readability, the test pattern 200 may be applied to output the operational pattern 300 on the display 102 and the process continues. In one example, if the vehicle operator specified that the test pattern 200 does enhance the display, the computer may ask the user if they would like the display to be adjusted further, e.g., by adjusting the same parameters further. If the user input specifies for the display 102 to be further adjusted, the process returns to the block 420. Otherwise the process continues. Alternatively, or additionally, whether by repeatedly inputting that the test pattern 200 does not enhance the display 102 or repeatedly inputting that the display 102 be enhanced further, the computer 106 may reach a predetermined limit of test patterns 200 to be presented and/or could exhaust possible test patterns 200. If the no further test patterns 200 are to be presented because none are available or the predetermined limit is in place and has been reached, the computer 106 may output via the vehicle HMI 112 that no further test patterns 200 are available and present a previous test pattern 200 to be applied to output the operational pattern 300 pending user input approving the test pattern 200.

Next, in a block 440, the computer 106 adjusts an operational pattern 300 of the display 102 as described above based on the user input. In other words, the computer 106 applies the approved test pattern 200 to the display 102 to adjust the operational pattern 300. As an example, if the vehicle operator inputs that the test pattern 200 does enhance the operator's perception of the display 102, e.g., readability of text 116 characters is enhanced, the test pattern 200 is applied to output the operational pattern 300 on the display, e.g., as shown in FIG. 3.

Then, as indicated in a block 445, the computer 106 monitors light conditions. A light condition could be determined by the vehicle computer 106 based at least in part on data collected by a sensor 108 in the vehicle 104. As an example, the computer 106 may monitor conditions values as illustrated in Table 1 above, such as time of day, light intensity, and orientation to the sun.

Then, as indicated in a block 450, the computer 106 makes a determination of whether to present a new test pattern 200 based on a determination of a prediction of squinting. The computer 106 can use the stored light conditions determined in the previous block 445 in combination with reference data, e.g., as described with respect to Table 1, to make a determination of a prediction of squinting. That is, a lookup table of the like could specify condition values according to which the computer 106 may determine a prediction that an occupant is squinting based on light conditions and may determine to present a test pattern 200. The condition values analyzed by the computer 106 and illustrated in Table 1 are light intensity, time of day, and orientation of the vehicle 104 relative to the sun as described above. As illustrated in Table 1, if the condition values exceed a pre-calibrated value the computer 106 may make a determination of a prediction of squinting and present a new test pattern 200. If the computer 106 determines a prediction of no squinting, the process continues.

Next, as indicated in a block 455, the computer 106 monitors driving conditions such as route conditions and environmental conditions. When driving conditions exceed a threshold or thresholds, the computer 106 may present a new test pattern 200. Specifically, if the vehicle operator inputs driving directions on the HMI 112, the vehicle 104 may consider speed and road condition data of the planned route and present a new test pattern 200 on the display 102. Road conditions include any condition of the road on which the vehicle is travelling that may affect an ability of the vehicle to navigate such as wet pavement, mud, cracks, etc. The combination of vehicle speed and road conditions are herein referred to as route conditions. As described above, the computer 106 may make a determination of when route conditions warrant a new test pattern 200 based on empirical testing, as stated above, e.g., according to an empirically determined threshold for a route and/or light condition or combination of driving conditions. The threshold(s) may be determined by driving a vehicle 104 under test driving conditions, e.g., combinations of amounts of snow, amounts of rain, pavement moisture, etc. that would be experienced by a vehicle operator in the course of operating the vehicle 104. Thresholds for different driving conditions can be combined. As an example, the computer 106 may present a test pattern 200 based on amounts of rain and wind That is, in this example, a first test pattern 200 is presented when thresholds of both an amount of rain and wind exceed respective first thresholds but are less than respective second thresholds, and a second test pattern 200 is presented when thresholds of the amounts of rain and wind both exceed the respective second thresholds.

Next, as indicated in a block 460, the computer 106 makes a determination of whether to present a new test pattern 200 based on a determination of whether an environmental condition is met. An environmental condition means a measurement or prediction of a physical condition outside the vehicle 104, such as a type of precipitation, an amount of precipitation, an ambient temperature, etc. As mentioned above, environmental conditions are determined in the block 455. The computer 106 may present a new test pattern 200 based on a determined environmental condition. If the computer 106 determines an environmental condition, the computer can present a new test pattern 200. As described above, the computer 106 may monitor the environmental condition and select a new test pattern 200 when the environmental condition has surpassed an empirically determined threshold. As an example, the environmental conditions may be rain and wind. If the chance of measurable rainfall at a point on the planned route is above a threshold, e.g., 50%, and/or an amount of expected rain is above a threshold, and the wind is expected to be or measured at over a wind threshold, e.g., 40 mph, the computer 106 may select a new test pattern 200 for display. As mentioned above, the test pattern 200 to be presented may differ based on different combinations of environmental conditions. For example, the test pattern 200 to be presented based on rain and wind may different than the test pattern 200 to be presented based on temperature and wind. If the computer 106 determines that the environmental condition is not met, a new test pattern 200 is not presented and the process continues.

In a block 465, the computer 106 determines whether to continue the process 400. For example, user input could specify that no new test pattern 200 is to be presented, thus ending the process 400. As another example, the vehicle 104 may be powered off to end the process 400. As a further example, user input may specify not to present further test patterns 200 and/or to provide a default operational pattern 300, and the process 400 would then end. Alternatively, if the process 400 is to continue, then the process returns to the block 445.

Examples are contemplated herein. Any example embodiment or feature described herein is not necessarily to be construed as preferred or advantageous over other embodiments or features. Further, the example embodiments described herein are not meant to be limiting. It will be readily understood that certain aspects of the disclosed systems and methods can be arranged and combined in a wide variety of different configurations, all of which are contemplated herein. In addition, the particular arrangements shown in the figures should not be viewed as limiting. It should be understood that other embodiments might include more or less of each element shown in a given figure. Additionally, some of the illustrated elements may be combined or omitted. Yet further, an example embodiment may include elements that are not illustrated in the figures.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A system, comprising a computer that includes a processor and a memory, the memory storing instructions executable by the processor including instructions to:
select a pattern for a display based on a determined age of an operator of a vehicle and a light condition in the vehicle;
present the pattern on the display; and
adjust the display based on input from the vehicle operator in response to the pattern.

2. The system of claim 1, wherein the light condition is determined at least in part based on an orientation of the vehicle with respect to the sun.

3. The system of claim 1, wherein the pattern defines at least one of a color, a font, or a scale of the display.

4. The system of claim 1, wherein the pattern increases a color contrast of the display.

5. The system of claim 1, wherein the instructions include instructions to select the pattern for display based on a vehicle speed in addition to the determined age of the vehicle operator and the light condition in the vehicle.

6. The system of claim 1, wherein the instructions further include instructions to select the pattern for display based on a road condition in addition to the determined age of the vehicle operator and the light condition in the vehicle.

7. The system of claim 1, wherein the instructions further include instructions to determine that the vehicle operator is wearing vision correctors and select the pattern for display based on a presence of vision correctors in addition to the determined age of the vehicle operator and the light condition in the vehicle.

8. The system of claim 1, wherein the instructions further include instructions to determine that the vehicle operator is squinting, and select the pattern further based on the squinting.

9. The system of claim 1, wherein the instructions further include instructions to receive user input selecting a parameter for the pattern, and then select the pattern further based on the user input.

10. The system of claim 1 wherein the instructions further include instructions to present the pattern based on at least one of vehicle speed, vehicle direction of travel, or road conditions.

11. The system of claim 1, wherein the instructions further include instructions to determine at least one of the vehicle operator age or the light condition based on an image received from a vehicle sensor.

12. A method, comprising:
selecting a pattern for a display based on a determined age of an operator of a vehicle and a light condition in the vehicle;
presenting the pattern on the display; and
adjusting the display based on input from the vehicle operator in response to the pattern.

13. The method of claim 12, wherein the light condition is determined at least in part based on an orientation of the vehicle with respect to the sun.

14. The method of claim 12, wherein the pattern defines at least one of a color, a font, or a scale of the display.

15. The method of claim 12, further comprising selecting the pattern for display based on at least one of a vehicle speed and a road condition in addition to the determined age of the vehicle operator and the light condition in the vehicle.

16. The method of claim 12, further comprising determining that the vehicle operator is wearing vision correctors and selecting the pattern for display based on a presence of vision correctors in addition to the determined age of the vehicle operator and the light condition in the vehicle.

17. The method of claim 12, further comprising determining that the vehicle operator is squinting, and selecting the pattern further based on the squinting.

18. The method of claim 12, further comprising receiving user input selecting a parameter for the pattern, and then selecting the pattern further based on the user input.

19. The method of claim 12, further comprising presenting the pattern based on at least one of vehicle speed, vehicle direction of travel, or road conditions.

20. The method of claim 12, further comprising determining at least one of the vehicle operator age or the light condition based on an image received from a vehicle sensor.
